(19) United States
(12) Patent Application Publication
(10) Pub. No.: US 2006/0176986 A1
(43) Pub. Date: Aug. 10, 2006

(54) Automatic gain control method and apparatus

(75) Inventor: Su Won Jung, Seoul (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/345,402

(22) Filed: Feb. 2, 2006

(30) Foreign Application Priority Data
Feb. 4, 2005 (KR) 10-2005-0010679

(51) Int. Cl. H04N 7/173; H04L 27/08

(52) U.S. Cl. 375/345; 725/111

(57) ABSTRACT

Disclosed herein are an automatic gain control apparatus and automatic gain control method for a broadcasting receiver equipped with a cable modem. The automatic gain control apparatus includes a splitter for splitting a received signal into a cable modem input signal and an external output broadcast signal, a gain selector for selecting any one of a first gain control signal outputted from a path of the external output broadcast signal and a second gain control signal outputted from a path of the cable modem input signal according to whether the cable modem has been activated, and an amplifier for adjusting a gain of the received signal in response to the first or second gain control signal selected by the gain selector. It is possible to stably perform the automatic gain control of the received signal by adjusting the gain of the received signal according to activation/deactivation of the cable modem.

This application claims the benefit of the Korean Patent Application No. 10-2005-0010679, filed on Feb. 4, 2005, which is hereby incorporated by reference as if fully set forth herein.

### BACKGROUND OF THE INVENTION

1. Field of the Invention

The present invention relates to an automatic gain control apparatus and an automatic gain control method, and more particularly, to an automatic gain control apparatus and automatic gain control method for a digital cable broadcasting receiver equipped with a cable modem.

2. Discussion of the Related Art

Recently, the demand for a digital cable broadcasting receiver with a cable modem is on an increasing trend. The cable broadcasting receiver with the cable modem splits a received radio frequency (RF) signal into a plurality of RF signals.

One split RF signal is inputted to an audio/video (A/V) tuner such that it is subjected to a decoding process in the broadcasting receiver. Another split RF signal is inputted to the cable modem so as to be subjected to a process for transmission thereof to a medium access control (MAC) layer.

Provided that the cable broadcasting receiver simply employs a passive device to split the received signal, it will have the disadvantage of being degraded in signal to noise ratio characteristic. In order to compensate for the degradation in signal to noise ratio characteristic, the cable broadcasting receiver may comprise a low-noise amplifier in front of the received signal splitting stage.

In this case, the cable broadcasting receiver must comprise an RF automatic gain controller at an RF input stage to be advantageous to improving the aforementioned noise characteristic. The RF automatic gain controller may perform an automatic gain control (AGC) operation using an output signal from the A/V tuner. In this case, however, whenever a broadcasting channel is changed, the RF signal input to the tuner suffers a variation, thereby causing the signal of the cable modem to be lost.

On the other hand, the RF automatic gain controller may perform the AGC operation using an output signal from a tuner of the cable modem. In this case, however, the RF automatic gain controller is not operated when the cable modem has not been activated.

### SUMMARY OF THE INVENTION

Accordingly, the present invention is directed to an automatic gain control method and apparatus that substantially obviates one or more problems due to limitations and disadvantages of the related art.

An object of the present invention is to provide an automatic gain control apparatus and method which can stably perform an automatic gain control of a received signal in a cable broadcasting receiver with a cable modem.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a method for automatically controlling a gain of a radio frequency (RF) signal received by a broadcasting receiver with a cable modem, comprising the steps of: (a1) determining whether the cable modem has been activated; and (b1) selecting any one of a gain control signal for a cable modem input signal and a gain control signal for an external output broadcast signal according to a result of the determination at the step (a1) and controlling the gain of the received RF signal with the selected gain control signal.

In another aspect of the present invention, there is provided a method for automatically controlling a gain of an RF signal received by a broadcasting receiver with a cable modem, comprising the steps of: (a2) determining whether the cable modem has been activated; and (b2) controlling the gain of the received RF signal with a gain control signal for a cable modem input signal, among signals into which the received RF signal is split, if it is determined at the step (a2) that the cable modem has been activated, and with a gain control signal for an external output broadcast signal, among the signals into which the received RF signal is split, if it is determined at the step (a2) that the cable modem has not been activated.

In another aspect of the present invention, an automatic gain control apparatus for a broadcasting receiver with a cable modem comprises: a splitter for splitting a received signal into a cable modem input signal and an external output broadcast signal; a gain selector for selecting any one of a first gain control signal outputted from a path of the external output broadcast signal and a second gain control signal outputted from a path of the cable modem input signal according to whether the cable modem has been activated; and an amplifier for adjusting a gain of the received signal in response to the first or second gain control signal selected by the gain selector.

Preferably, the gain selector comprises: an inverter for receiving an activation signal indicative of whether the cable modem has been activated; a first AND gate for performing an AND operation with respect to the activation signal and the cable modem input signal; and a second AND gate for performing the AND operation with respect to an output signal from the inverter and the external output broadcast signal.

The activation signal may be ‘1’ when the cable modem has been activated, and ‘0’ when the cable modem has not been activated.

In yet another aspect of the present invention, an automatic gain control apparatus for a broadcasting receiver with a cable modem comprises: a splitter for splitting a received RF signal into an external output broadcast signal and a cable modem input signal; a gain selector for outputting a gain control signal for the cable modem input signal only when the cable modem has been activated; and an amplifier for adjusting a gain of the received RF signal in response to the gain control signal from the gain selector.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram showing the configuration of an exemplary embodiment of an automatic gain control apparatus according to the present invention; and

FIG. 2 is a flow chart illustrating an exemplary embodiment of an automatic gain control method according to the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

Besides, although terms used in the present invention are possibly selected from the currently well-known ones, some terms are arbitrarily chosen by the inventor in some cases so that their meanings are explained in detail in the following description. Hence, the present invention should be understood with the intended meanings of the corresponding terms chosen by the inventor instead of the simple names or meanings of the terms themselves.

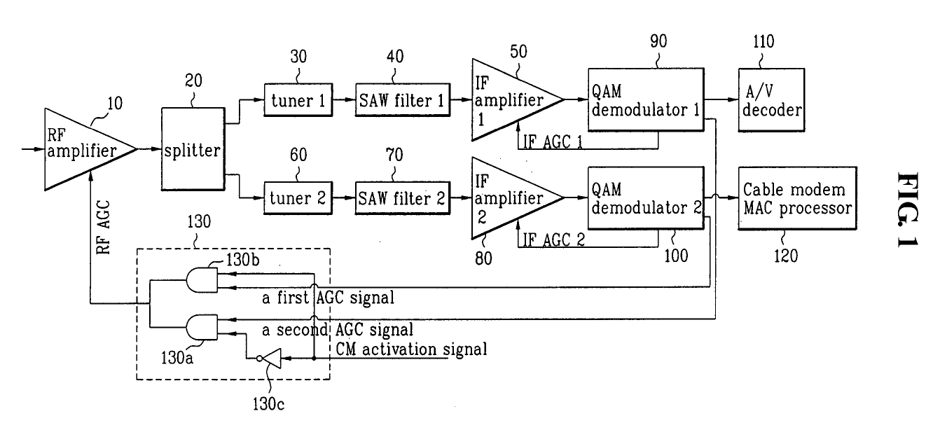

FIG. 1 is a block diagram showing the configuration of an exemplary embodiment of an automatic gain control apparatus according to the present invention. A description will hereinafter be given of the operation of the exemplary embodiment of the automatic gain control apparatus according to the present invention with reference to FIG. 1.

If a cable broadcasting receiver with a cable modem receives an RF signal, a low-noise amplifier 10 adjusts the gain of the received RF signal using an RF AGC signal.

A splitter 20 directly decodes the gain-adjusted signal into a broadcast signal and splits the decoded broadcast signal into a broadcast signal to be externally outputted and a broadcast signal to be inputted to the cable modem.

For the convenience of description, the broadcast signal to be externally outputted will hereinafter be referred to as a first signal or external output broadcast signal and the broadcast signal to be inputted to the cable modem will hereinafter be referred to as a second signal or cable modem input signal.

The split external output broadcast signal and cable modem input signal are inputted to a first tuner 30 and second tuner 80, respectively. The tuners 30 and 80 convert the inputted signals into intermediate frequency (IF) signals and output the converted IF signals, respectively.

A first surface acoustic wave (SAW) filter 40 filters and outputs the IF signal from the first tuner 30 at a desired frequency band and a second SAW filter 90 filters and outputs the IF signal from the second tuner 80 at a desired frequency band.

A first IF amplifier 50 amplifies and outputs the output signal from the first SAW filter 40 using an IF AGC signal fed back from a first demodulator 60. Similarly, a second IF amplifier 100 amplifies and outputs the output signal from the second SAW filter 90 using an IF AGC signal fed back from a second demodulator 110.

The first demodulator 60 demodulates the output signal from the first IF amplifier 50 in a quadrature amplitude modulation (QAM) manner and outputs the resulting transport stream. An A/V decoder 70 decodes the transport stream from the first demodulator 60 and outputs the resulting audio/video signal.

The second demodulator 110 demodulates the output signal from the second IF amplifier 100 in the QAM manner and outputs the resulting transport stream, which is the demodulated result of the cable modem input signal. This transport stream is inputted to a MAC processor 120 of the cable modem.

Meanwhile, each of the first demodulator 60 and second demodulator 110 outputs an AGC signal to be used for the gain adjustment of the received RF signal to a gain selector 130.

The gain selector 130 receives the AGC signals outputted respectively from the path of the external output broadcast signal and the path of the cable modem input signal, and a cable modem (CM) activation signal indicative of whether the cable modem has been activated.

The gain selector 130 selects any one of the AGC signal (referred to hereinafter as a first AGC signal) outputted from the path of the external output broadcast signal and the AGC signal (referred to hereinafter as a second AGC signal) outputted from the path of the cable modem input signal and outputs the selected AGC signal as the RF AGC signal to the low-noise amplifier 10, which is an RF amplifier. The RF amplifier 10 receives the selected AGC signal as the RF AGC signal and amplifies the received RF signal using the RF AGC signal.

For example, the activation signal indicates that the cable modem has been activated, when it is ‘1’, and that the cable modem has not been activated, when it is ‘0’.

The gain selector 130 selects and outputs any one of the first AGC signal or second AGC signal in response to the activation signal, namely, according to whether the activation signal is 1 or 0 in the above example.

To this end, the gain selector 130 includes an inverter 130c for receiving the activation signal, and first and second AND gates 130a and 130b.

The inverter 130c receives the CM activation signal and inverts and outputs it. That is, when the activation signal is 1, namely, when the cable modem has been activated, the inverter 130c outputs 0. On the contrary, when the activation signal is 0, the inverter 130c outputs 1.

Only one of the first AND-gate 130a and second AND gate 130b outputs a corresponding one of the first AGC signal and second AGC signal in response to the output signal from the inverter 130c.

When the cable modem has not been activated, only the first AND gate 130a outputs the first AGC signal. On the contrary, when the cable modem has been activated, only the second AND gate 130b outputs the second AGC signal.

Therefore, if the user changes a channel under the condition that the cable modem has been activated, an RF signal of a changed frequency is received, but the RF frequency of the cable modem is not changed, thus stabilizing the gain control of the received RF signal.

In addition, when the cable modem has not been activated, because the signal on the path for externally outputting the video/audio signal is valid, it is possible to control the gain of the received RF signal using the first AGC signal.

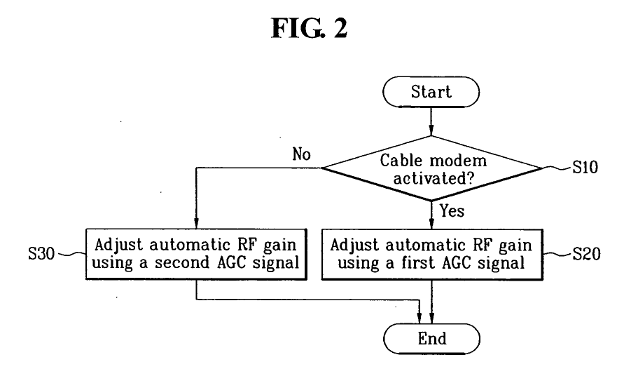

FIG. 2 is a flow chart illustrating an exemplary embodiment of an automatic gain control method according to the present invention. A description will hereinafter be given of the exemplary embodiment of the automatic gain control method according to the present invention with reference to FIG. 2.

For an automatic gain control of a received RF signal in a broadcasting receiver equipped with a cable modem, first, a determination is made as to whether the cable modem has been activated (S10).

If it is determined that the cable modem has been activated, an AGC signal for a signal to be inputted to the cable modem, among signals into which the received RF signal is split, is selected and the automatic gain control of the received RF signal is performed using the selected AGC signal (S20).

In the case where it is determined that the cable modem has not been activated, an AGC signal for a signal to be externally outputted, among the signals into which the received RF signal is split, is selected and the automatic gain control of the received RF signal is performed using the selected AGC signal (S30).

As apparent from the above description, the present invention provides an automatic gain control apparatus and method which can stably perform an automatic gain control of a received signal by adjusting the gain of the received signal according to activation/deactivation of a cable modem.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method for automatically controlling a gain of a radio frequency (RF) signal received by a broadcasting receiver with a cable modem, comprising the steps of:
(a) determining whether the cable modem has been activated; and
(b) selecting any one of a gain control signal for a cable modem input signal and a gain control signal for an external output broadcast signal according to a result of the determination at the step (a) and controlling the gain of the received RF signal with the selected gain control signal.

2. A method for automatically controlling a gain of an RF signal received by a broadcasting receiver with a cable modem, comprising the steps of:
(a) determining whether the cable modem has been activated; and
(b) controlling the gain of the received RF signal with a gain control signal for a cable modem input signal, among signals into which the received RF signal is split, if it is determined at the step (a) that the cable modem has been activated, and with a gain control signal for an external output broadcast signal, among the signals into which the received RF signal is split, if it is determined at the step (a) that the cable modem has not been activated.

3. An automatic gain control apparatus for a broadcasting receiver with a cable modem, comprising:
a splitter for splitting a received signal into a cable modem input signal and an external output broadcast signal;
a gain selector for selecting any one of a first gain control signal outputted from a path of the external output broadcast signal and a second gain control signal outputted from a path of the cable modem input signal according to whether the cable modem has been activated; and
an amplifier for adjusting a gain of the received signal in response to the first or second gain control signal selected by the gain selector.

4. The automatic gain control apparatus as set forth in claim 3, wherein the gain selector comprises:
an inverter for receiving an activation signal indicative of whether the cable modem has been activated;
a first AND gate for performing an AND operation with respect to the activation signal and the cable modem input signal; and
a second AND gate for performing the AND operation with respect to an output signal from the inverter and the external output broadcast signal.

5. The automatic gain control apparatus as set forth in claim 4, wherein the activation signal is ‘1’ when the cable modem has been activated, and ‘0’ when the cable modem has not been activated.

6. An automatic gain control apparatus for a broadcasting receiver with a cable modem, comprising:
a splitter for splitting a received RF signal into an external output broadcast signal and a cable modem input signal;
a gain selector for outputting a gain control signal for the cable modem input signal only when the cable modem has been activated; and
an amplifier for adjusting a gain of the received RF signal in response to the gain control signal from the gain selector.
